(19) United States
(12) Patent Application Publication
(10) Pub. No.: US 2023/0339137 A1
(43) Pub. Date: Oct. 26, 2023

(54) SAWING DEVICE

(71) Applicant: Weinmann Holzbausystemtechnik GmbH, St. Johann (DE)

(72) Inventor: Karl WEINMANN, St. Johann (DE)

(73) Assignee: Weinmann Holzbausystemtechnik GmbH, St. Johann (DE)

(21) Appl. No.: 18/214,655

(22) Filed: Jun. 27, 2023

Related U.S. Application Data
(63) Continuation-in-part of application No. 17/296,736, filed on May 25, 2021, now Pat. No. 11,717,983.

(30) Foreign Application Priority Data
Dec. 13, 2018 (DE) 10 2018 132 101.5

(51) Int. Cl. B27G 19/02; B27B 27/10

(52) U.S. Cl. CPC B27G 19/02; B27B 27/10

(57) ABSTRACT

A sawing device, in particular for separating long workpiece parts, has a saw blade and a retaining device for separated workpiece parts, wherein the retaining device has a retaining element, at least on the side of the saw blade facing the workpiece part that is to be separated, which retaining element is arranged ahead of the saw blade in the machining direction of the workpiece and movably in such a way that it is movable from an inactive position above the workpiece into an active position which reaches ahead of the front end of the workpiece.

### CROSS REFERENCE TO RELATED APPLICATIONS

This application is a divisional of and Applicants claim priority under 35 U.S.C. § 120 of U.S. patent application Ser. No. 17/296,736 filed on May 25, 2021, which application is a national stage application under 35 U.S.C. § 371 of PCT Application No. PCT/EP2019/084718 filed on Dec. 11, 2019, which claims priority under 35 U.S.C. § 119 from German Patent Application No. 10 2018 132 101.5 filed on Dec. 13, 2018, the disclosures of each of which are hereby incorporated by reference. A certified copy of priority German Patent Application No. 10 2018 132 101.5 is contained in parent U.S. patent application Ser. No. 17/296,736. The International Application under PCT article 21(2) was not published in English.

### BACKGROUND OF THE INVENTION

### 1. Field of the Invention

The invention relates to a sawing device, in particular for separating long workpiece parts, comprising a saw blade and a retaining device for separated workpiece parts.

### 2. Description of the Related Art

In CNC machines having sawing devices, parts that have been separated from the workpiece can be accelerated by the saw blade and thrown out of the machine's work region. These ejected parts pose a significant danger to people in the vicinity of the machine. Retaining devices in the form of curtains are therefore usually provided on such CNC machines as splinter protection. In machines with large machining bridges for solid wood panels, impact walls are provided on the front sides of the machine's work table and are intended to hold back parts thrown out by the saw blade.

However, it has been shown that these safety measures are insufficient. In particular, long separated parts can easily break through protective curtains. The impact walls on the work table are firstly expensive and secondly ineffective in the case of bevel cuts and cuts perpendicular to the transport direction of the workpiece through the sawing device.

### SUMMARY OF THE INVENTION

The object of the present invention is therefore to provide a sawing device having effective protection against parts being thrown out.

This object is achieved by a sawing device, in particular for separating long workpiece parts, comprising a saw blade and a retaining device for separated workpiece parts, which sawing device is characterized in that the retaining device has a retaining element, at least on the side of the saw blade facing the workpiece part that is to be separated, which retaining element is arranged ahead of the saw blade in the machining direction of the workpiece and movably in such a way that it is movable from an inactive position above the workpiece into an active position which reaches ahead of the front end of the workpiece.

In the sawing device according to the invention, the retaining device is arranged close to the saw blade and is already effective before the saw cut is completed. This means that separated workpiece parts are not accelerated or only slightly accelerated by the saw blade and therefore cannot pose a risk to people in the vicinity. The at least one retaining element can be moved in front of the front end of the workpiece even before the workpiece is completely severed by the saw blade. After separating the waste portion of the workpiece, it can be accelerated for a maximum of a few centimeters by the saw blade before it hits the retaining element. There is therefore at most a minimal acceleration of the waste portion, and therefore the retaining element does not have to be a heavy, solid component and can therefore be easily moved along with the sawing device.

The retaining device of the sawing device according to the invention is effective completely regardless of the direction of the saw cut. This makes it possible for the first time to provide reliable protection against flung waste portions, even with oblique or vertical saw cuts. With this protection, which is effective under all conditions, it is even possible to carry out manual work on the same workpiece during sawing.

It is advantageous if the retaining device has a retaining element on both sides of the saw blade. As a result of this symmetrical design of the retaining device, it is effective regardless of whether the waste portion of the workpiece is separated on the left or the right side of the workpiece.

In a preferred embodiment of the sawing device, the retaining element or elements may be pivotably arranged on the sawing device in such a way that they can be pivoted from an inactive position resting on the surface of the workpiece into an active position reaching ahead of the front end of the workpiece. By resting on the upper face of the workpiece, the retaining element or elements can easily detect the front end of the workpiece shortly before the saw blade reaches said front end. Of course, in addition to a pivotable arrangement of the retaining elements, a linearly displaceable arrangement of said elements is also possible.

Particular advantages are produced if the retaining element or elements can be automatically moved into their active position shortly before the saw blade reaches the front end of the workpiece. This can be achieved, for example, in that the at least one retaining element in its inactive position slides in a spring-loaded manner along the workpiece surface and, when the front end of the workpiece is reached, is moved downward by the spring force into its active position in front of the front end of the workpiece.

The retaining elements may be movable between their inactive and active positions for example by means of cylinder arrangements. At least the movement into the active position can take place automatically as described above. Of course, however, a sensor-controlled drive device may also be provided for the at least one retaining element.

In a preferred embodiment, the invention relates to a sawing device comprising a saw blade for separating parts from workpieces, a retaining device for preventing a kick-back of the separated parts, and a sensor-controlled drive device for driving at least one retaining element of the retaining device between the inactive position and the active position and preferably vice versa. Furthermore, the sensor-controlled drive device comprises a first sensor unit, which is arranged on the sawing device in such a way, that the first sensor unit is able to detect an end face of a workpiece before the saw blade is able to fully separate a part from the workpiece. The sensor-controlled drive device allows for an active control of the at least one retaining element.

Preferably the retaining device—viewed in a machining direction of the sawing blade—is located in an area of a front side of the sawing device and the first sensor unit viewed in the machining direction of the sawing blade is located between the retaining device and the saw blade. This preferred arrangement allows the first sensor unit to be placed as close as possible to the point where the end face of the workpiece passes. This facilitates the detection of the end face of the workpiece.

Preferably, the first sensor unit uses a distance measurement between the first sensor unit and the surface of the workpiece. A change of the measured distance at the end face of the workpiece can be used as an indication, that the saw blade has nearly reached the end face of the workpiece and therefore the at least one retaining element must change its position from the inactive position to the active position.

In a further preferred embodiment, the first sensor unit operates contactless. This embodiment does not need a mechanical contact between the retaining element and the workpiece to detect the end face of the workpiece before the saw blade fully separates a part from the workpiece. Such an operation avoids a damage to the surface of the workpiece and such an operation is wear-free.

Preferably, the sawing device further comprises a control device for controlling the sensor-controlled drive device, and wherein the control device is adapted to instruct the sensor-controlled drive device to drive the at least one retaining element into the active position, when the first sensor unit has detected the end face of the workpiece. The use of a control device allows besides the control of the sensor-controlled drive device further control options of the sawing device with respect to safety of operators of the sawing device such as emergency shutdowns of the sawing device.

In a further preferred embodiment, the sensor-controlled drive device further comprises a status monitoring device for the retaining device for monitoring, whether the retaining element is in the active position or the inactive position. This embodiment allows to verify, whether the retaining device is properly working or not.

Preferably, the status monitoring device is a second sensor unit. Using two sensor units for the sawing device further improves the safety of the operator of the sawing device. If both sensor units—the first sensor und and the second sensor unit—are of the same type, production costs may be reduced.

In preferred embodiments, the second sensor unit may use a light barrier, an acoustic distance measurement, an optical distance measurement or at least one electrical contact in a travel track for the retaining element.

Preferably, the control device is further adapted to stop a relative movement between the sawing device and the workpiece, when the status monitoring device has detected that the retaining device is not properly working. This further control option of the control device improves the safety of the operator of the sawing device.

In a further preferred embodiment, the sawing device further comprises a drive for the relative movement between the sawing device and the workpiece and a drive control unit for the drive. The control device is further adapted to instruct the drive control unit to stop the relative movement between the sawing device and the workpiece, when the second sensor unit has detected that the retaining device is not properly working. The further preferred embodiment is a specific implantation for providing additional safety for the operator of the sawing device.

The retaining element or elements may preferably be designed to be flap-like or slide-like.

Further advantages are produced if the retaining element or elements have a sliding surface by means of which they slide along the workpiece surface in their inactive position during sawing of the workpiece. As a result, they do not hinder the movement of the saw blade or the advance of the workpiece. It is further preferable if the sliding surface is a convex surface. This results in only linear contact between retaining element and workpiece surface, which further reduces mutual friction.

The invention also includes a machining apparatus for wood, metal, plastics or glass materials comprising a sawing device according to the invention. Said machining apparatus maybe part of a CNC machining center by means of which further machining of the workpiece is possible. The sawing device may preferably be used for machining beams or wall panels, but is not limited to these applications.

The invention also relates to a method for separating workpiece parts, in particular long workpiece parts, using a sawing device which comprises a saw blade and a retaining device, the retaining device having a retaining element, at least on the side of the saw blade facing the workpiece part that is to be separated, which retaining element is arranged ahead of the saw blade in the machining direction of the workpiece and movably in such a way that it is movable from an inactive position above the workpiece into an active position which reaches ahead of the front end of the workpiece, which method is characterized in that, before the start of the sawing process, the at least one retaining element is moved into its inactive position and, shortly before the complete separation of the workpiece part by the saw blade, is moved into its active position.

The invention also relates to a method for separating parts from workpieces, which comprises the following steps scanning an area in front of a saw blade with respect to a machining direction of a sawing device, verifying, whether at least one front end of a workpiece is within the scanned area, and moving at least one retaining element from an inactive position to an active position for preventing a kick-back of a part separated from the workpiece, when the area has been reached by the front end of the workpiece.

Preferably, the scanning is a contactless scanning. A sawing process based on such a contactless scanning does not need a mechanical contact between the retaining element and the workpiece to detect the end face of the workpiece before the saw blade fully separates a part from the workpiece. Thus, a damage of the top surface of the workpiece can be avoided. Furthermore, there exists no wear at the contact interface of the retaining element with the workpieces.

In a further preferred embodiment, the method further comprises the step of monitoring the active position and/or inactive position of the retaining element, verifying whether the retaining element has been moved from the inactive position to the active position when the area has been reached by the front end of the workpiece, and stopping awing process at the workpiece, when detecting that the retaining device has not been properly moved from the inactive position to the active position. The further preferred embodiment allows to control a proper functioning of the retaining device. Thus, the further preferred embodiment provides additional safety for the operator.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 is a schematic side view of a sawing device having a retaining device;

FIG. 2 is a view from behind of the sawing device from FIG. 1;

FIG. 3A) is a schematic side view of a further sawing device having a retaining device in an inactive position;

FIG. 3B) is a direction of view rotated by 90° along a vertical axis of the further sawing device shown in FIG. 3A);

FIG. 4 is a schematic side view of the further sawing device having the retaining device in an active position;

FIG. 5A) is a top view on a rectangular workpiece when being separated by the sawing devices with respect to FIG. 1 to FIG. 4;

FIG. 5B) is a top view on a non-rectangular workpiece when being separated by the sawing devices with respect to FIG. 1 to FIG. 4;

FIG. 6 shows schematically a method for separating workpiece parts by using a sensor-controlled drive device for moving at least one retaining element of a retaining device from the inactive position to the active position; and

FIG. 7 shows a perspective view of a CNC machining center with a machining apparatus which comprises a sawing device according to FIG. 1 to FIG. 4.

### DETAILED DESCRIPTION OF PREFERRED EMBODIMENTS

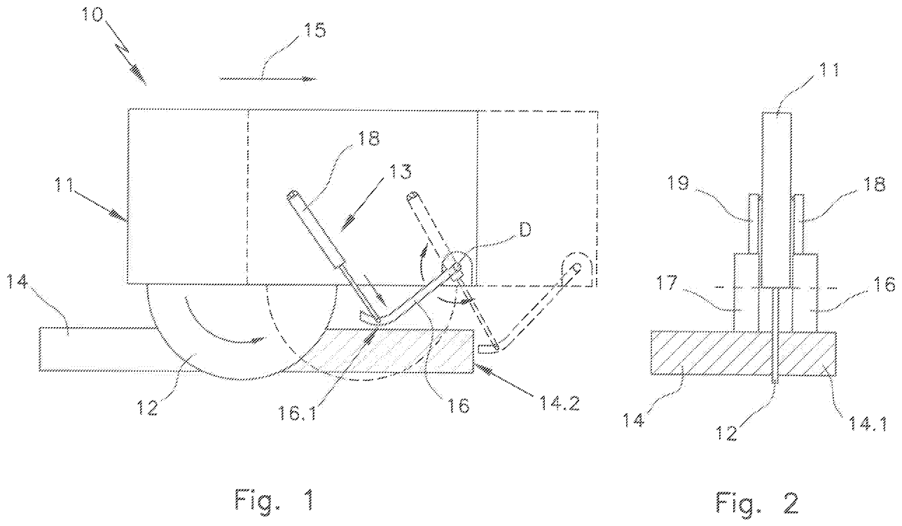

FIG. 1 shows a sawing device 10 having a housing 11 for a saw blade 12. A retaining device 13 for separated parts 14.1 (FIG. 2) of a workpiece 14 is also arranged on the housing 11. In the example shown, the sawing device 10 moves in the direction of the arrow 15 over the workpiece 14, which is clamped on a work table (not shown). The direction of the arrow 15 therefore also indicates the machining direction of the workpiece 14. As can be seen, the retaining device 13 is arranged on the sawing device 10 ahead of the saw blade 12 in the machining direction 15 of the workpiece 14.

The retaining device 13 comprises a flap-like retaining element 16, 17 on both sides of the saw blade 12 that is arranged on the sawing device 10 so as to be pivotable about an axis D, as also shown in particular in the rear view from FIG. 2. Each retaining element is acted upon by a cylinder 18, 19, by means of which the retaining element 16, 17 can be pivoted from an inactive position indicated by solid lines in FIG. 1 into an active position shown by dashed lines and back. The retaining elements 16, 17 are in their inactive position until shortly before reaching a front end 14.2 of the workpiece, in which inactive position they rest on the upper face of the workpiece and slide along it.

In order to facilitate this sliding, the retaining elements 16, 17 are provided with a convex sliding surface 16.1, which is formed by a curved free end of the retaining elements 16, 17.

If the saw blade then approaches the front end 14.2 of the workpiece 14, the retaining elements 16, 17 are pressed by the cylinders 18, 19 into their active position, in which they reach ahead of the front end 14.2 of the workpiece 14. Therefore, after the workpiece 14 has been completely severed, the saw blade 12 cannot accelerate the separated part 14.1 (FIG. 2) and throw it out of the sawing device. Rather, the separated part 14.1 strikes the retaining element 16 and is held back by it.

Even with a stationary sawing device 10 and a moving workpiece 14, the retaining device 13 would fulfill the same safety function. In this case, the workpiece would be moved counter to the direction of the arrow 15 and the retaining elements 16, 17 would be moved, just before the workpiece 14 is severed, ahead of the front end 14.2 in the machining direction 15 of the workpiece 14, where they can hold back a workpiece part 14.1 accelerated by the saw blade 12.

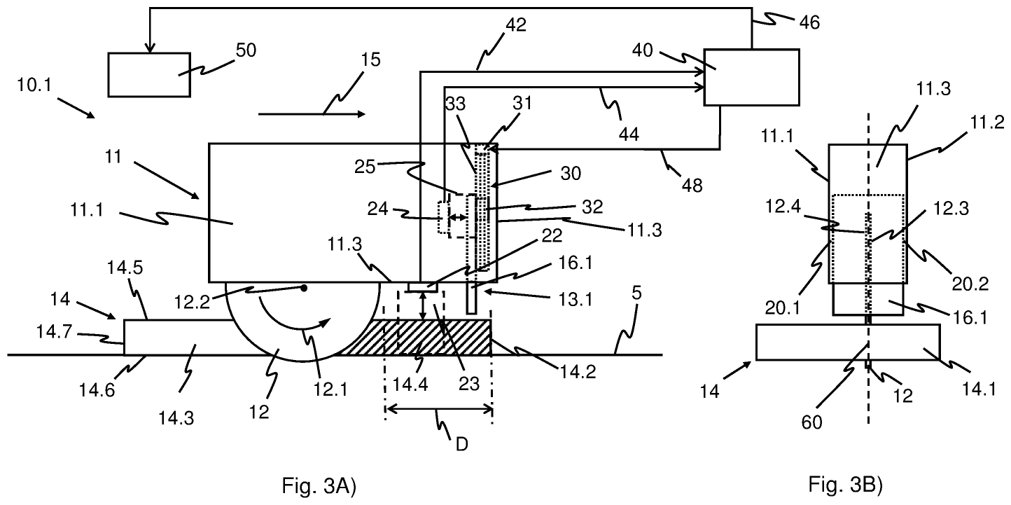

FIGS. 3A and 3B show a further embodiment of sawing device 10.1. Identical reference signs of the embodiment of FIG. 1 and FIG. 2 and the further embodiment of FIGS. 3A and 3B stand for identical technical components. The sawing device 10.1 comprises the saw blade 12 and the housing 11 for the saw blade 12. The sawing device 10.1 is operated in the machining direction 15. The machining direction 15 is based on a relative movement between the sawing device 10.1 and the workpiece 14 to be cut by the sawing device 10.1. The relative movement can be realized either by a movement of the sawing device 10.1 with respect to an unmoved workpiece 14 lying on and clamped to the worktable 5, by a movement of the workpiece 14 with respect to the unmoved sawing device 10.1 or by a combined movement of the sawing device 10.1 and the workpiece 14.

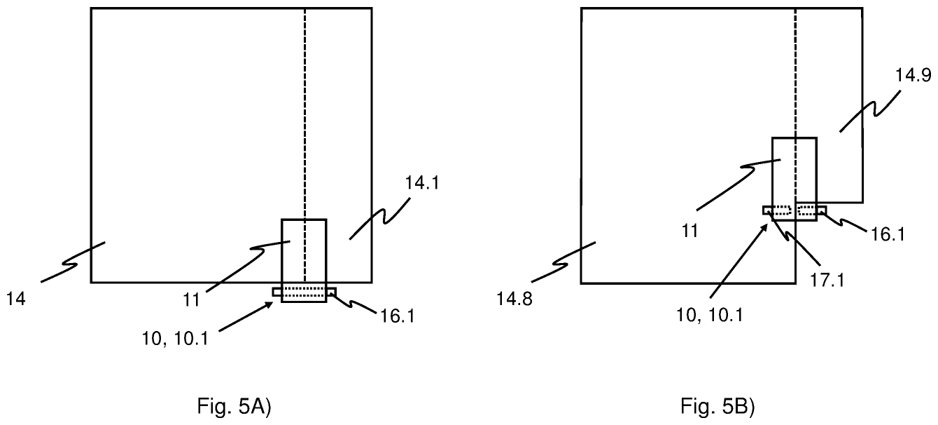

The sawing device 10.1 further comprises a retaining device 13.1 for parts 14.1 separated from the workpiece 14. The retaining device 13.1 comprises either a single retaining element 16.1 (see FIG. 5A) or two retaining elements 16.1, 17.1 (see FIG. 5B) each in form of for example a rectangular plate or a square plate. Alternatively, the retaining element(s) 16.1, 17.1 may be designed to be flap-like or slide-like. The retaining element(s) 16.1, 17.1 may be preferably made of hardened steel.

Preferably, the retaining device 13.1 is located—viewed in the machining direction 15 of the saw blade 12—in the area of a front side of the sawing device 10.1. The front side of the sawing device 10.1 may be limited by a front wall 11.3 of the housing 11.

Preferably, the retaining device 13.1 may be at least party arranged inside the housing 11 at the front wall 11.3 of the housing 11 as shown in FIG. 3A). This arrangement allows to protect a sensor-controlled drive device 30 of the retaining device 13.1 to be protected against sawing dust by the housing 11. A width of the retaining element 16.1 or a combination of the two retaining elements 16.1, 17.1 arranged side by side is preferably adapted to an inner diameter of the housing 11 which is perpendicular to the machining direction 15 of the workpiece 14. Thereby, spacings between inner faces of walls 11.1, 11.2 of the housing 11 and the retaining element 16.1 or the combination of the two retaining elements 16.1, 17.1 are preferably in the order of few millimeters such as between 1 mm and 5 mm (see FIG. 3B). The walls 11.1, 11.2 are preferably vertically oriented and are parallel oriented to the machining direction 15 (see FIG. 3B).

The retaining element 16.1 is located at least on a side 12.3 of the saw blade 12, which faces the part 14.1 that is to be separated from the workpiece 14.

The retaining element 16.1 may be alternatively located on both sides 12.3, 12.4 of the saw blade 12, if usually workpieces 14 with rectangular dimensions have to be cut. This provides more flexibility in separating parts from the workpieces 14.

Alternatively, the retaining element 16.1 may be located on the side 12.3 of the saw blade 12 and the retaining element 17.1 may be located on the side 12.4 of the saw blade 12, if occasionally or usually workpieces 14 with non-rectangular dimensions have to be cut.

Alternatively (not shown in the figures), the retaining device 13.1 may be arranged on an outer wall 11.3 of the housing 11. The outer wall 11.3 is preferably vertically oriented and is oriented perpendicular to the machining direction 15 of the workpiece 14 (see FIG. 3B) and is arranged at the rear end of the housing 11 as seen in the machining direction 15. This arrangement allows a larger width of the retaining element 16.1 or the combination of the retaining element 16.1 and the retaining element 17.1 arranged side by side in comparison to the retaining element 16.1 of the embodiment shown in FIG. 3A), because the width of the retaining element 16.1 or the combination of the retaining element 16.1 and the retaining element 17.1 is not limited by the inner diameter of the housing 11. Thereby, protection of an operator against kick-back of the parts 14.1 separated from the workpiece 14 can be increased.

A thickness of the material of the retaining element is preferably adapted to the material of the workpiece 14. In case of wood or plastic, a first thickness of the material of the retaining element may be in a range between 3 mm to 5 mm. In case of metal or glass, a second thickness of the material of the retaining element may be in a range between 5 mm to 10 mm. This thickness of the retaining element adapted to the material to be cut allows also for an improved protection of the operator of the sawing device 10.1.

A width of the retaining element(s) 16.1, 17.1 in the horizontal direction is preferably adapted to a width of parts to be separated from the workpiece 14. In case of parts to be separated with a width below or equal to a predefined width of for example 30 cm, the retaining element may extend from a two-dimensional sawing plane 60 (see FIG. 3B) in a direction perpendicular to the sawing plane 60 with a distance of at least 5 cm up to half of a maximum width of the parts to be separated from the workpiece 14. In case of parts to be separated with a width above the predefined width, the retaining element may extend from the two-dimensional sawing plane 60 in the direction perpendicular to the sawing plane 60 with a distance of at least 15 cm up to half of the maximum width of the parts to be separated from the workpiece 14. This width of the retaining element adapted to the maximum width of the parts 14.1 separated from the workpiece 14 allows also for an improved protection of the operator of the sawing device 10.1.

The retaining device 13.1 further comprises a sensor-controlled drive device 30 for the retaining element 16.1. The sensor-controlled drive device 30 is preferably arranged inside the housing 11 at the rear end of the housing 11 as seen in the machining direction 15 (see FIG. 3A). Alternatively, if the retaining device 13.1 may be arranged on an outer wall 11.3 of the housing 11, the drive device 30 may be also arranged at the outer wall 11.3 of the housing 11.

The sensor-controlled drive device 30 may be realized for example by a worm drive 31 as an example of a mechanical drive, which moves a support plate 32 along a vertically oriented linear guideway 33 between two guide rails as sketched in FIG. 3A). The retaining element 16.1 is mounted to the support plate 32, so that the retaining element 16.1 can be moved vertically up and down by the sensor-controlled drive device 30.

Alternatively, the sensor-controlled drive device 30 may be realized by an electromechanical drive, a direct electric linear drive, a hydraulic linear drive or a pneumatic linear drive.

In a further alternative embodiment, the retaining element 16.1 or the combination of the retaining elements 16.1, 17.1 may be pivotably arranged inside or outside the housing 11 similar to the embodiment of FIG. 1 in such a way that they the retaining element 16.1 or the combination of the retaining elements 16.1, 17.1 can be pivoted from the inactive position to the active position reaching ahead of the front end 14.2 of the workpiece 14.

The saw blade 12 is preferably a circular saw blade. For dividing the workpiece 14 the circular saw blade 12 and the workpiece 14 viewed in vertical direction are arranged in such a way to each other that a pivot point 12.2 of the circular saw blade 12 is located above a top surface 14.5 of the workpiece 14. A rotation direction 12.1 of the saw blade 12 is preferably oriented in such a way, that the workpiece 14 is divided from a bottom surface 14.6 of the workpiece 14 to the top surface 14.5 of the workpiece 14 (see FIG. 3A).

The sensor-controlled drive device 30 comprises a first sensor unit 22. The first sensor unit 22 is preferably arranged on the sawing device 10.1 is such a way, that the first sensor unit 22 is able to detect an end face 14.2 of the workpiece 14 (see FIG. 5A), 14.8 (see FIG. 5B) before the saw blade 12 is able to fully separate a part 14.1 (see FIG. 5A), 14.9 (see FIG. 5B) from the workpiece 14, 14.8.

Preferably, the retaining device 13.1—viewed in the machining direction 15 of the saw blade 12—may be located in the area of a front side of the sawing device 10.1, and the first sensor unit 22 may be arranged preferably at a bottom side 11.3 of the housing 11 between the saw blade 12 and the retaining device 13.1.

The first sensor unit 22 is preferably a distance sensor, which measures preferably continuously a vertical distance between the first sensor unit 22 and the top surface 14.5 of the workpiece 14. The first sensor unit 22 may be preferably a non-contact sensor which operates contactless such as an ultrasonic sensor or a laser sensor. Alternatively, a sensor with a mechanical contact such as a spring force sensor may be used for the first sensor unit 22.

Preferably, the sensor-controlled drive device 30 further comprises a status monitoring device 24, which is for example arranged inside the housing 11 in such a vertical position, which allows to detect a working condition of the retaining device 13.1 such as a presence of the retaining element 16.1 in the inactive position (see FIG. 3A).

The status monitoring device 24 may be preferably a second sensor unit. The second sensor unit may comprise components for a light barrier such as at least one optical transmitter and at least one optical receiver placed side-by-side to the retaining element(s) 16.1, 17.1 in the inactive position or the active position, so that the retaining element(s) is/are able to block the optical transmission between the at least one optical transmitter and the at least one optical receiver, when it is in the respective position.

Alternatively, the second sensor unit may comprise a least one component for an acoustic distance measurement such as at least one ultrasonic sensor located near the area of the retaining element, when it is in the active position and/or the inactive position.

In a further alternative, the second sensor unit may comprise a least one component for an optical distance measurement such as at least one laser sensor or light emitting diode located near the area of the retaining element, when it is in the active position and/or the inactive position.

In an even further alternative, the second sensor unit may comprise a least one component for at least one electrical contact in a guideway 33 for the at least one retaining element 16.1, 17.1 such as at least one switch, which opens or closes an electrical circuit, when the retaining element(s) 16.1, 17.1 is/are in the active position and/or the inactive position.

In a further alternative, the second sensor unit may comprise a least one component for a digital measurement probing such as a measuring probe, which contacts the retaining element(s) 16.1, 17.1 mechanically, when the retaining element(s) 16.1, 17.1 is/are in the active position and/or the inactive position.

The saw device 10.1 further comprises a control device 40 for controlling the sensor-controlled drive device 30 and optionally also for monitoring the functionality of the retaining device 13.1. Alternatively, the control device 40 may be part of a machining apparatus for wood, metal, plastics or glass materials, which comprises the sawing device 10.1. The control device 40 may comprise a processor unit and a memory unit.

The saw device 10.1 further comprises a first signal line 42 between the first sensor unit 22 and the control device 40 for providing measurement signals of the first sensor unit 22 to the control device 40. For the embodiments where the status monitoring device 24 is present, the saw device 10.1 preferably further comprises a second signal line 44 between the status monitoring device 24 and the control device 40 for providing measurement signals of the status monitoring device 24 to the control device 40.

The saw device 10.1 further comprises a drive control unit 50 for example for a first drive (not shown), which drives the saw blade 12 for example into rotation, and for a second drive (not shown), which drives at least one translation unit (not shown) either for the saw blade 12, for the workpiece 14 or for the saw blade 12 and the workpiece 14. Preferably, the saw device 10.1 further comprises a third signal line 46 between the control device 40 and the control unit 50 for providing control signals from the control device 40 to the control unit 50.

Preferably, the saw device 10.1 further comprises a fourth signal line 48 between the control device 40 and the sensor-controlled drive device 30 for providing control signals of the control device 40 to the drive device 30.

When the saw device 10.1 begins to separate the part 14.1 from the workpiece 14 by moving the saw blade 12 in the machining direction 15, the retaining element 16.1 is in its inactive position above the top surface 14.5 of the workpiece 14. A distance between the top surface 14.5 of the workpiece 14 and the lowest part of the retaining element 16.1 may be for example in a range between 5 mm and 1 cm. FIG. 3A) shows a situation where the saw blade 12 has roughly reached the middle of the predefined saw cut line of the workpiece 14. Section 14.3 of the workpiece 14 has been already cut and shaded section 14.4 of the workpiece 14 has not yet been cut.

The first sensor unit 22 has not yet measured any change in the vertical distance between the first sensor unit 22 and the top surface 14.5 of the workpiece 14 since the beginning of the cutting process for the predefined saw cut line of the workpiece 14. Therefore, the retaining element 16.1 is still in its inactive position above the top surface 14.5 of the workpiece 14.

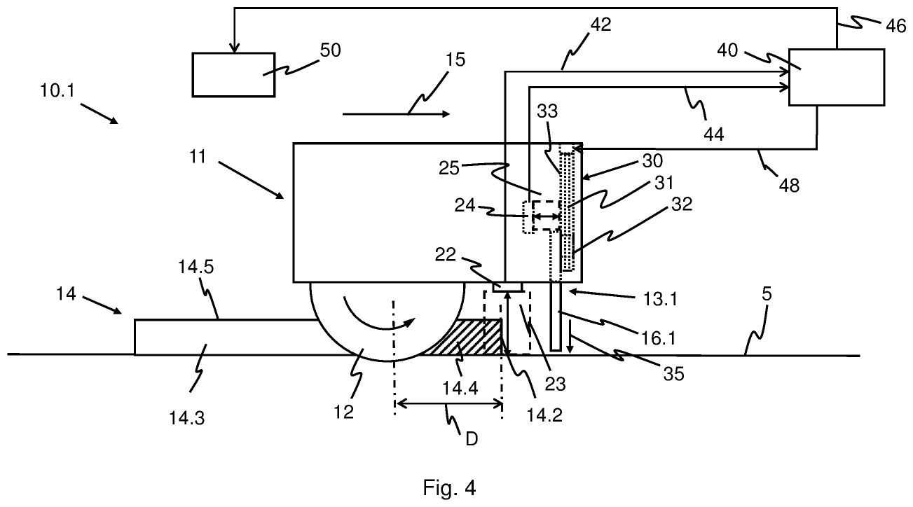

FIG. 4 shows a further situation later in time where the saw blade 12 has roughly reached the second part of the predefined saw cut line of the workpiece 14 and where the first sensor unit 22 is no longer located above the top surface 14.5 of the workpiece 14. The front end 14.2 of the workpiece 14 has just passed the first sensor unit 22, so that the radiation of the first sensor unit 22 is no longer fully reflected from the top surface 14.5 of the workpiece 14. Instead, the radiation is at least partly reflected from the top surface of the work table 5. This change in the reflection preferably being above a predefined value to avoid false triggering of the retaining element 16.1 to move into the active position may be interpreted by the first sensor unit 22 itself as a change in distance, so that a different distance value is signaled or transmitted to the control device 40 via the first signal line 42. Alternatively, the change in reflection is measured as a drop in intensity of the reflected signal and corresponding measurement values are signaled or transmitted to the control device 40, which interprets the change measurement values as a change in distance. As shown in FIG. 4, the control device 40 has already send a control signal to the drive device 30 via the fourth signal line 48, which has instructed the drive device 30 to move the retaining element 16.1 of the retaining device 13.1 in a vertical direction 35 from the inactive position to the active position. The active position may be characterized by a distance between the top surface of the work table 5 and the lowest part of the retaining element 16.1 being for example in a range between 5 mm and 1 cm. In the active position the retaining element 16.1 is now able to block a kick-back movement of the part 14.1 in the machining direction 15, when the part 14.1 is fully separated from the workpiece 14.

As shown in FIG. 4, the control device 40 has already send a control signal to the drive device 30 via the fourth signal line 48, which has instructed the drive device 30 to move the retaining element 16.1 of the retaining device 13.1 in a vertical direction 35 from the inactive position to the active position. Thereby, an upper part of the retaining element 16.1 has passed the status monitoring device 24 being for example a second sensor unit, so that the radiation of the second sensor unit is no longer reflected from the surface of the upper part of the retaining element 16.1. Instead, the radiation is reflected from parts of the linear guideway 33. This change in the reflection preferably being above a predefined value to avoid a false assumption that the retaining element 16.1 works well may be interpreted by the second sensor unit itself as a change in distance, so that a different distance value is signaled or transmitted to the control device 40 via the second signal line 44. Alternatively, the change in reflection is measured as a drop in intensity of the reflected signal and corresponding measurement values are signaled or transmitted to the control device 40, which interprets the change measurement values as a change in distance. Based on the detected distance change at the first sensor unit 22 and based on the detected distance at the second sensor unit, the control device 40 has the information, that the retaining device 13.1 is properly working.

Otherwise, if the control device 40 has detected only the distance change at the first sensor unit and has not detected within a predefined time slot after the distance change at the first sensor unit 22 also a distance change at the second sensor unit, which means that the retaining device 13.1 is not properly working, the control device 40 is adapted to send a control signal to the drive control unit 50 to stop immediately at least the second drive of the translation unit and preferably also the first drive for the saw blade 12 for safety reasons.

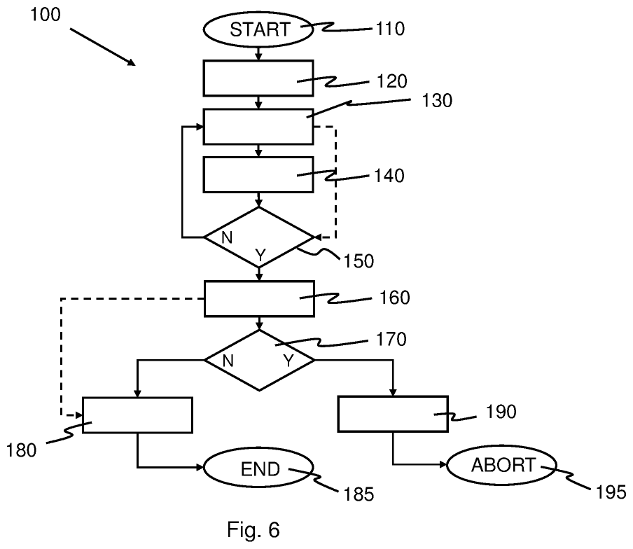

FIG. 6 shows details of a method 100 for separating parts from workpieces such as the part 14.1 from the workpiece 14 or the part 14.9 from the workpiece 14.8 as shown in FIG. 1 to FIG. 5. The method 100 for a single predefined cut at the workpiece 14, 14.8 starts in block 110.

In a step 120, when the workpiece 14, 14.8 is clamped on the work table 5 and the saw device 10.1 is moved to cut the workpiece 14, 14.8 (corresponding to one of the three alternatives mentioned above for a relative movement between the saw device 10.1 and the workpiece 14, 14.8), the drive control unit 50 may start the first drive for the saw blade 12, so that the saw blade 12 of the sawing device 10.1 begins to rotate, and may start the second drive, so that the sawing device 10.1 begins to move linearly towards a rear end or first lateral surface 14.7 of the workpiece 14.

When the drives have been started, in a further step 130 an area 23 in front of the saw blade 12 with respect to the machining direction 15 is continuously scanned preferably in a contact-less way (see FIGS. 3A and 3B) or scanned within predefined time slots of for example 100 milliseconds preferably by the first sensor unit 22 for detecting the front end face 14.2 of the workpiece 14. The contact-less scanning may be for example based on a distance measurement by ultrasonic waves or by optical waves. Alternatively, for a contact measurement probing a digital measuring probe or a pressing shoe with a sliding surface may be used.

In a further optional step 140, the inactive position of the retaining element 16.1 or the combination of the retaining element 16.1, 17.1 is continuously monitored (see FIGS. 3A and 3B) or monitored within the predefined time slots of for example 100 milliseconds. Preferably, an area 25 of the inactive position of the retaining element 16.1 is monitored in a contact-less for example by the second sensor unit 24. The area 25 may be characterized, that the area 25 is at least partly covered by the retaining element 16.1, when the retaining element 16.1 is in the inactive position and that the area 25 is fully uncovered by the retaining element 16.1, when the retaining element 16.1 is in the active position.

In a further step 150 it is verified, whether the front end 14.2 of the workpiece 14 is within the scanned area 23. As long as the measured distance at the first sensor unit 22 does not increases between two successive measurements preferably above a predefined value to avoid false triggering of a movement of the retaining element 16.1, the area 23 has not been reached by the front end 14.2 of the workpiece 14. In such a case, the method 100 repeats the step 130.

Instead, when the measured distance at the first sensor unit 22 increases between two successive measurements by at least a predefined threshold value, the area 23 has been reached by the front end 14.2 of the workpiece 14 (see FIG. 4). In such a case, the method 100 continues with step 160.

By the step 160, the drive device 30 is instructed to move the retaining element 16.1 for example in a vertical direction from the inactive position to the active position.

In a further optional step 170 it is verified after the predefined time slot started by the distance change at the first sensor unit 22, whether the retaining element 16.1 has been moved from the inactive position to the active position. The predefined time slot may be chosen by an addition of time periods needed for signaling from the first sensor element 22 to the control device 40, for processing at the control device 40, for signaling from the control device 40 to the drive device 30 and for moving the retaining element 16.1 from the inactive position to the active position. When monitoring of the area 25 indicates, that the retaining element 16.1 has been moved from the inactive position to the active position, the method 100 continues with step 180.

In the step 180, the separating of the part 14.1 from the workpiece 14 is finalized. In such a case, the method 100 ends with block 200. Instead, when monitoring of the area 25 indicates, that the retaining element 16.1 has not been properly moved from the inactive position to the active position, the method 100 continues with an optional step 190.

In the optional step 190, a sawing process of the sawing device 10.1 at the workpiece 14 is going to be stopped by stopping the rotation of the saw blade 12 and the translation of the saw blade 12. Alternatively, if for example the sawing device 10.1 is fixed and the workpiece is moved, the movement of the workpiece 14 is stopped. In such a case, the method 100 aborts with block 210. Then, an operator of the sawing device must check the reason for unforeseen abort of the method 100.

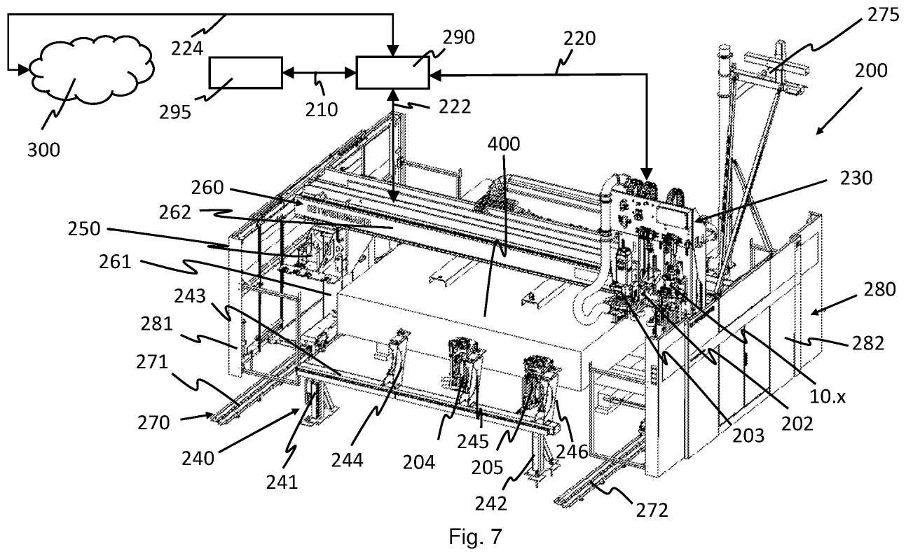

FIG. 7 shows a preferred embodiment of a CNC machining center 200 as a so-called multifunction bridge with various machining units 10.x, 202, 203, 204, 205 for processing a workpiece module system 400, in particular a framework, which preferably consists of wood, metal, plastics or glass materials.

The machining unit 10.x is one of the previously described sawing devices 10, 10.1 for cutting workpieces such as beams, laths or wall panels of the workpiece module system 400. The other machining units 202, 203, 204, 205 comprise processing devices, for example for drilling, fastening, marking, gluing or formatting.

The CNC machining center 200 comprises a machining apparatus 230 for two, three or even more than three of the machining units 10.x, 202, 203, 204, 205. The machining units 10.x, 202, 203 arranged on the machining apparatus 230 can be used directly for processing the workpiece module system 400. The machining apparatus 230 preferably comprises at least one drive spindle for those machining devices that require such a drive spindle, such as drilling devices or the sawing devices 10, 10.1. At least one of the machining units 202, 203, 204, 205 preferably comprises a tool changer for various machining functions. The machining apparatus 230 preferably comprises an arrangement for a machining unit 10.x which can be rotated by at least 180° about a vertical direction, preferably in an automated manner.

Those machining units 204, 205 which cannot be accommodated on the machining apparatus 130 can be parked on a support 240 of the CNC machining center 200, which is preferably arranged on a front side of a support table (not visible in FIG. 7) of the CNC machining center 200, and thus preferably on a support surface of the CNC machining center 200. The support 240 preferably comprises a first vertical beam 241 anchored to the support surface and a second vertical beam 242 anchored to the support surface. The support 240 further comprises a horizontal beam 243 arranged and fixed to the upper ends of the two vertical beams 241, 242. The rack 240 further comprises at least one bracket 244, 245, 246 arranged on the horizontal beam 243 for one of the machining units 10.x, 202, 203, 204, 205. Preferably, two or more brackets 244, 245, 246 are arranged on the horizontal beam 243.

The machining apparatus 230 is preferably arranged to be horizontally movable and vertically movable on a gantry system 260 as a positioning device of the CNC machining center 200 by means of corresponding drive devices. The gantry system 260 comprises a first vertical beam 261, a second vertical beam not visible in FIG. 7 and a horizontal beam 262 arranged and fastened on the upper ends of the vertical beams 261, on which the machining apparatus 230 is movably arranged in order to be able to approach the machining positions necessary for machining the workpiece module system 400.

Preferably, the CNC machining center 200 further comprises a tool changer 250 arranged on the vertical support 261 to enable further tools to be changed into one of the machining units 202, 203.

The gantry system 260 is arranged to be horizontally movable along the support table on a transport device 270 by means of a drive device, which is not shown. The transport device 270 is preferably a rail system comprising a first rail 271 and a second rail 272. The rails 271, 272 are preferably arranged at the side of the support table for the workpiece module system 400. Depending on the size of the workpiece module system 400, the CNC machining center 200 can also comprise two or more support tables arranged one behind the other, along which the gantry system 260 can be moved. The rails 271, 272 preferably have such a length that the gantry system 260 can be moved up to above the position 240 in order to exchange, preferably automatically, at least one of the machining units 10.x, 202, 203 of the machining apparatus 230 for at least one of the other machining units 204, 205 for a forthcoming machining of the workpiece module system 400.

As an alternative to the gantry system 260, a multi-axis robot can also be used as a positioning device, which is preferably also arranged to move along the support table on a rail system.

The CNC machining center 200 further preferably comprises a protective wall system 280 for operating personnel of the CNC machining center 200. The protective wall system 280 comprises, for example and preferably, a first protective wall 281, which is arranged parallel to the first rail 271 on the first vertical support 261 of the gantry system 260, and a second protective wall 282, which is arranged parallel to the second rail 272 on the second vertical support 262 of the gantry system 260. In this way, the protective wall system 280 moves with the gantry system 260 and provides protection where machining is currently taking place by means of the CNC machining center 200. The protective wall system 280 provides besides the retaining device 13, 13.1 of the saw device 10, 10.1 a further protection of the operator of the CNC machining center 200, when the saw device 10, 10.1 is used to separate parts 14.1, 14.9 from workpieces 14, 14.8 for the workpiece module system 400.

The CNC machining center 200 further comprises a vertically upwardly extending bar and profile arrangement 275 arranged on the horizontal beam 262, via which supply lines for power and compressed air, for example, from a hall ceiling to the CNC machining center 200, and disposal lines, such as for a chip extraction system, are routed from the CNC machining center 200 to the hall ceiling.

The CNC machining center 200 also comprises a control device 290 shown schematically in FIG. 7 and a control center 295 shown schematically in 7. The control center 295 is, for example, a touch-sensitive screen or a computer with a keyboard and/or mouse as input device. Information can be exchanged between the control device 290 and the control center 295 via a first control line 210. A second control line 220 can be used to exchange information between the control device 290 and the machining apparatus 230 in order to control the machining apparatus 230 itself and in particular the machining units 10.x, 202, 203. A third control line 222 can be used to exchange information between the control device 290 and the gantry system 260, in particular to move the gantry system 260 to a predefined position and preferably also to report back that the predefined position has been reached.

The CNC machining center 200 preferably exchanges information with a higher-level production controller, which may be located in a cloud 300, for example, via a fourth control line 224. The cloud 300 may, for example, be a central server of a production site. The cloud 300 preferably provides production data of the CNC machining center 200, with which the CNC machining center 200 produces the workpiece module system 400 to be produced, preferably in a largely automated or fully automated manner.

Preferably, the CNC machining center 200 described in reference to FIG. 7 is used to carry out the method 100 described in reference to FIG. 6 for separating workpiece parts 14.1, 14.9.

Although only a few embodiments of the present invention have been shown and described, it is to be understood that many changes and modifications may be made thereunto without departing from the spirit and scope of the invention.

What is claimed is:

1. A sawing device (10.1) comprising a saw blade (12) and a retaining device (13.1) for separated workpiece parts (14.1, 14.9), wherein the retaining device (13.1) comprises at least one retaining element (16.1, 17.1), at least on one side of the saw blade (12) facing the workpiece part (14.1, 14.9) that is to be separated from a workpiece (14, 14.8), which at least one retaining element (16.1, 17.1) is arranged ahead of the saw blade (12) in a machining direction (15) of the workpiece (14, 14.8) and movably in such a way that the at least one retaining element (16.1, 17.1) is movable from an inactive position above the workpiece (14, 14.8) into an active position which reaches ahead of a front end (14.2) of the workpiece (14, 14.8), wherein the sawing device (10.1) further comprises a sensor-controlled drive device (30) to move the at least one retaining element (16.1, 17.1) between the inactive position and the active position.

2. The sawing device (10.1) according to claim 1, wherein the retaining device (13.1) comprises the at least one retaining element (16.1, 17.1) on both sides of the saw blade (12).

3. The sawing device (10.1) according to claim 1, wherein the at least one retaining element (16.1, 17.1) is pivotably arranged on the sawing device (10.1) in such a way that the at least one retaining element (16.1, 17.1) can be pivoted from the inactive position into the active position reaching ahead of the front end (14.2) of the workpiece (14, 14.8).

4. The sawing device (10.1) according to claim 1, wherein the at least one retaining element (16.1, 17.1) is designed to be flap-like or slide-like.

5. A machining apparatus (230) for wood, metal, plastics or glass materials comprising a sawing device (10.1) according to claim 1.

6. The machining apparatus (230) according to claim 5, wherein the machining apparatus (230) it is part of a CNC machining center (200).

7. A method (100) for separating workpiece parts using a sawing device (10.1) which comprises a saw blade (12) and a retaining device (13.1), the retaining device (13.1) comprises a at least one retaining element (16.1, 17.1), at least on one side of the saw blade (12) facing the workpiece part (14.1, 14.9) that is to be separated from a workpiece (14, 14.8), which at least one retaining element (16.1, 17.1) is arranged ahead of the saw blade (12) in a machining direction (15) of the workpiece (14, 14.8) and movably in such a way that it the at least one retaining element (16.1, 17.1) is movable from an inactive position above the workpiece (14, 14.8) into an active position which reaches ahead of the front end (14.2) of the workpiece (14, 14.8),
wherein, before the start of a sawing process, the retaining element (16.1, 17.1) is moved into the inactive position and, before the complete separation of the workpiece part (14.1, 14.9) by the saw blade (12), is moved into the active position by a sensor-controlled drive device (30).

8. A sawing device (10.1) comprising a saw blade (12) for separating parts (14.1, 14.9) from workpieces (14, 14.8), a retaining device (13.1) for preventing a kick-back of the separated parts (14.1, 14.9), and a sensor-controlled drive device (30) for driving at least one retaining element (16.1, 17.1) of the retaining device (13.1) between an inactive position and an active position, wherein the sensor-controlled drive device (30) comprises a first sensor unit (22), wherein the first sensor unit (22) is arranged on the sawing device (10.1) is such a way, that the first sensor unit (22) is able to detect an end face (14.2) of a workpiece (14, 14.8) before the saw blade (12) is able to fully separate a part (14.1, 14.9) from the workpiece (14, 14.8).

9. The sawing device (10.1) according to claim 8, wherein the retaining device (13.1) —viewed in a machining direction (15) of the sawing blade (12) —is located in the area of a front side of the sawing device (10.1), and wherein the first sensor unit (22) viewed in the machining direction (15) of the sawing blade (12) is located between the retaining device (13.1) and the saw blade (12).

10. The sawing device (10.1) according to claim 8, wherein the first sensor unit (22) uses a distance measurement between the first sensor unit (22) and a surface of the workpiece (14, 14.8).

11. The sawing device (10.1) according to claim 8, wherein the first sensor unit (22) operates contactless.

12. The sawing device (10.1) according to claim 8, wherein the sawing device (10.1) further comprises a control device (40) for controlling the sensor-controlled drive device (30), and wherein the control device (40) is adapted to instruct the sensor-controlled drive device (30) to drive the at least one retaining element (16.1, 17.1) into the active position, when the first sensor unit (22) has detected the end face (14.2) of the workpiece (14, 14.8).

13. The sawing device (10.1) according to claim 8, wherein the sensor-controlled drive device (30) further comprises a status monitoring device (24) for the retaining device (13.1) for monitoring, whether the retaining element is in the active position or the inactive position.

14. The sawing device (10.1) according to claim 13, wherein the status monitoring device (24) is a second sensor unit.

15. The sawing device (10.1) according to claim 14, wherein the second sensor unit comprises at least one component for a light barrier, for an acoustic distance measurement, for an optical distance measurement or for at least one electrical contact in a guideway (33) for the at least one retaining element (16.1, 17.1) or for a contact measurement probing.

16. The sawing device (10.1) according to claim 12, wherein the sensor-controlled drive device (30) further comprises a status monitoring device (24) for the retaining device (13.1) for monitoring, whether the retaining element is in the active position or the inactive position, and wherein the control device (40) is further adapted to stop a relative movement between the sawing device (10.1) and the workpiece (14, 14.8), when the status monitoring device (24) has detected that the retaining device (13.1) is not properly working.

17. The sawing device (10.1) according to claim 16, wherein the status monitoring device is a second sensor unit (24), wherein the sawing device (10.1) further comprises a drive for the relative movement between the sawing device (10.1) and the workpiece (14, 14.8) and a drive control unit (50) for the drive, and wherein the control device (40) is further adapted to instruct the drive control unit (50) to stop the relative movement between the sawing device (10.1) and the workpiece (14, 14.8), when the second sensor unit (24) has detected that the retaining device (13.1) is not properly working.

18. A CNC machining center (200) for wood, metal, plastics or glass materials comprising a sawing device (10.1) according to claim 12.

19. The CNC machining center (200) according to claim 18, wherein the CNC machining center (200) is a multifunction bridge.

20. A method (100) for separating parts (14.1, 14.9) from workpieces (14, 14.8) comprising the steps of scanning an area (23) in front of a saw blade (12) with respect to a machining direction (15) of a saw blade (12) of a sawing device (10.1), verifying (150) whether at least one front end (14.2) of a workpiece (14, 14.8) is within the scanned area (23), and moving (160) at least one retaining element (16.1, 17.1) from an inactive position to an active position for preventing a kick-back of a part (14.1, 14.9) separated from the workpiece (14, 14.8), when the area (23) has been reached by the at least on front end (14.2) of the workpiece (14, 14.8).

21. The method (100) according to claim 20, wherein the method (100) further comprises the step of monitoring (140) the inactive position and/or the active position of the at least one retaining element (16.1, 17.1), verifying (170) whether the at least one retaining element (16.1, 17.1) has been moved from the inactive position to the active position, when the area (23) has been reached by the at least one front end (14.2) of the workpiece (14, 14.8), and stopping (190) a relative movement between the sawing device (10.1) and the workpiece (14, 14.8), when it has been detected that the at least one retaining device (16.1, 17.1) has not been properly moved from the inactive position to the active position.
